(19) United States
(12) Patent Application Publication
(10) Pub. No.: US 2011/0001729 A1
(43) Pub. Date: Jan. 6, 2011

(54) ELECTRONIC DEVICE USING ELECTROMAGNETIC INPUT DEVICE

(75) Inventor: KIM-YEUNG SIP, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY ( ShenZhen) CO., LTD., Shenzhen City (CN); HON HAI PRECISION INDUSTRY CO., LTD., Tu-Cheng (TW)

(21) Appl. No.: 12/541,116

(22) Filed: Aug. 13, 2009

(30) Foreign Application Priority Data
Jul. 1, 2009 (CN) 200910303909.3

(51) Int. Cl. G06F 3/033

(52) U.S. Cl. 345/179

(57) ABSTRACT

An electronic device includes an electromagnetic input device, a memory, and a processor. The electromagnetic input device includes a movable magnetized stylus and an inducting module. The inducting module includes a number of inducting cells and a controller. Each inducting cell includes a coil for generating an inducting voltage according to the change of magnetic flux through the coil. The controller determines the type of movement of the stylus according to the inducting voltages generated by the coils of the inducting cells. The memory stores a number of operating commands corresponding to a number of types of movements of the stylus. The processor generates an operating command for operating the electronic device corresponding to the type of movement of the stylus determined by the controller.

### BACKGROUND

1. Technical Field

The present disclosure relates to electronic devices and, particularly, to an electronic device having electromagnetic input device.

2. Description of Related Art

Recently, touch input devices such as touch screens are widely used in electronic devices. Generally, these touch input devices include a touch panel and a stylus for operating the electronic devices. However, it's inconvenient to use such touch input device, because the stylus must touch the touch panel when operating the electronic device and this may cause scratches on the touch panel.

What is needed, therefore, is an electronic device to overcome or at least mitigate the above-described problem.

### BRIEF DESCRIPTION OF THE DRAWINGS

Many aspects of the present electronic device can be better understood with reference to the accompanying drawings. The components in the drawings are not necessarily drawn to scale, the emphasis instead being placed upon clearly illustrating the principles of the present electronic device. In the drawings, all the views are schematic.

FIG. 1 is block functional view of an electronic device according to an exemplary embodiment.

FIG. 2 is a schematic view of an electromagnetic input device of the electronic device of FIG. 1.

FIG. 3 is a schematic view of an inducting layer of the electromagnetic input device of FIG. 2.

FIG. 4 is a schematic view of an inducting cell of the inducting layer of FIG. 3.

FIG. 5 is block functional view of an inducting module of the electromagnetic input device of FIG. 2.

### DETAILED DESCRIPTION

Embodiments of the present disclosure will now be described in detail below, with reference to the accompanying drawings.

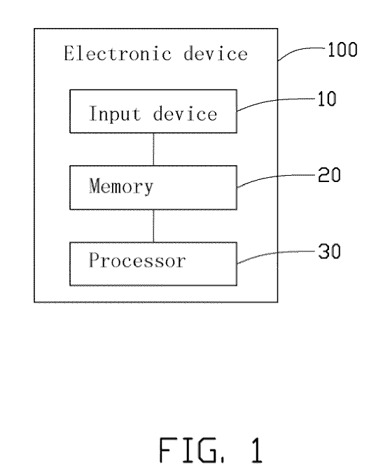

Referring to the FIG. 1, an electronic device 100, according to an embodiment, is shown. The electronic device 100 includes an electromagnetic input device 10, a memory 20, and a processor 30.

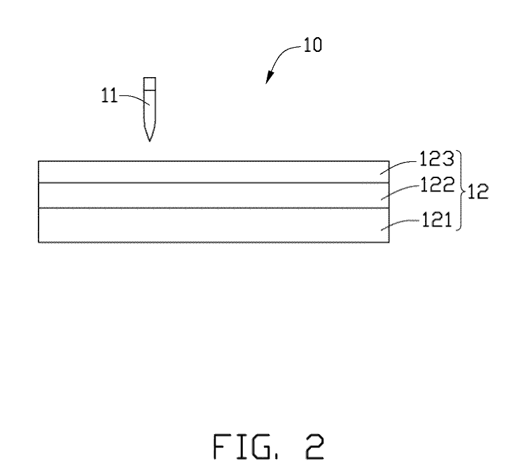

Referring to FIG. 2, the electromagnetic input device 10 includes a stylus 11 and an inducting module 12. In the present embodiment, the stylus 11 is a magnetized pen, and the inducting module 12 is a touch screen, although any other input device such as a hand-written panel is equally applicable while remaining well within the scope of the disclosure.

The inducting module 12 is configured for sensing the movement of the stylus 11. In the present embodiment, the inducting module 12 includes a substrate 121, an inducting layer 122, and a cover 123. The substrate 121 is configured for supporting the inducting layer 122, and the cover 123 is configured for protecting the inducting layer 122. The inducting layer 122 is sandwiched between the substrate 121 and the cover 123. In this embodiment, the inducting module 12 is transparent. The substrate 121 and the cover 123 are made of glass or transparent resin. In other embodiments, the substrate 121 can also be omitted, and the inducting layer 122 is attached to and supported by the cover 123.

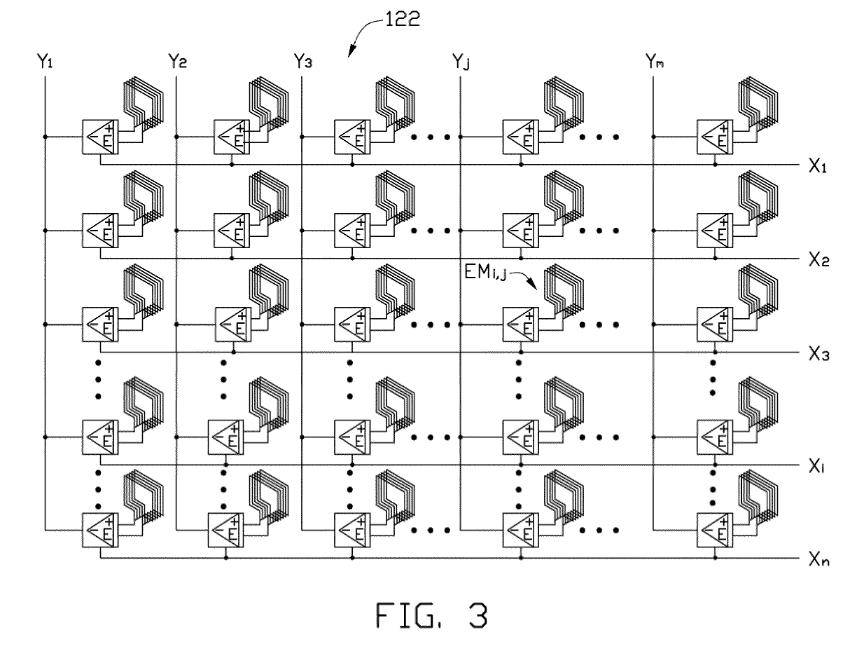

Referring to FIG. 3, the inducting layer 122 includes n×m inducting cells EMi,j, n gate lines Xi, and m output lines Yj, where i=1, 2, . . . n, and j=1, 2, . . . m. Each inducting cell EMi,j includes a coil Ci,j and a differential unit Di,j.

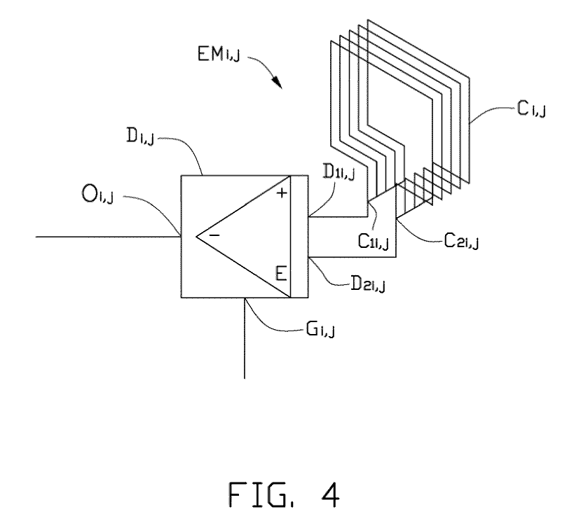

Further referring to FIG. 4, the coil Ci,j includes a first output terminal C1i,j and a second output terminal C2i,j. The coil Ci,j is operable to sense the change in magnetic flux though the coil Ci,j, and generate a corresponding induced voltage. The induced voltage between the first and second output terminals C1i,j and C2i,j is proportional to the rate of the change of the magnetic flux through the coil Ci,j. In this embodiment, if the magnetic flux through the coil Ci,j increases, the induced voltage is positive. The coil Ci,j is made of an electrically conductive transparent material such as indium tin oxide (ITO).

The differential unit Di,j includes a first input terminal D1i,j, a second input terminal D2i, j, a third output terminal Oi, j, and a gate terminal Gi,j. The first and second input terminals D1i,j, D2i, j are connected to the first and second output terminals C1i,j, C2i,j, so as to receive the induced signal from the first and second output terminals C1i,j, C2i,j respectively. The gate terminal Gi, j is connected to a gate line Xi. The third output terminal Oi, j is connected to an output line Yj. The gate terminal Gi,j is operable to receive a gate signal so as to enable the differential unit Di,j. The third output terminal Oi, j is operable to output a differential signal with a differential voltage proportional to the induced voltage. In this embodiment, the induced voltage is amplified in the differential unit Di,j such that the differential voltage is greater than the induced voltage.

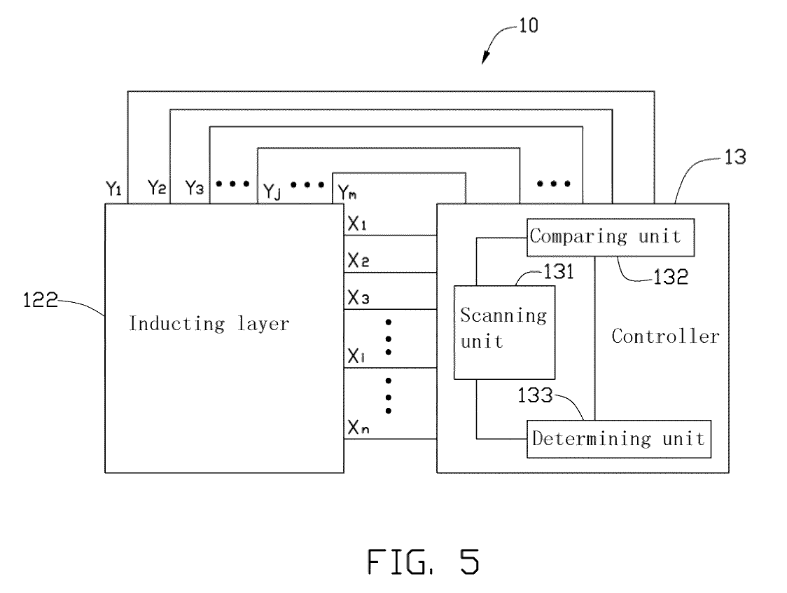

Referring to FIG. 5, the electromagnetic input device 10 further includes a controller 13. The controller 13 includes a scanning unit 131, a comparing unit 132, and a determining unit 133. The scanning unit 131 is connected to the gate lines Xi. The comparing unit 132 is connected to the output lines Yj.

The scanning unit 131 is operable to output gate signals to the gate lines Xi, line by line, to enable the differential units Di,j to output the differential signals. The comparing unit 132 stores a predetermined positive threshold voltage. The comparing unit 132 is configured for comparing the largest differential voltage of the differential units Di,j of the inducting layer 122 to the predetermined positive threshold voltage. The determining unit 133 can determine the position of the stylus 11 relative to the inducting layer 122 according to the comparing result of the comparing unit 132, and determine the type of movement of the stylus 11 according to the position change of the stylus 11. If the largest differential voltage of the differential units Di,j of the inducting layer 122 is larger than the predetermined positive threshold voltage, the determining unit 133 will determine that the stylus 11 is substantially close to/near the coil Ci,j of the inducting layer 122 corresponding to the largest differential voltage. In order to prevent the determining unit 133 from misinterpreting minor movements and/or trembling of the stylus 11 as input operations, when the largest differential voltage of the differential units Di,j of the inducting layer 122 is smaller than the predetermined positive threshold voltage, the determining unit 133 cannot determine the position of the stylus 11.

The memory 20 stores a number of operating commands corresponding to a number of types of movements of the stylus 11. The type of the movement can be distinguished according to characteristics of the movements of the stylus 11. The characteristics of the movements of the stylus 11 include acceleration, speed, direction and so on. In the present embodiment, the type of the movement is distinguished according to the moving direction.

The processor 30 is electrically connected to the controller 13 and the memory 20. The processor 30 can generate an operating command for operating the electronic device 100 corresponding to each type of movement of the stylus 11 relative to the inducting layer 122. In other embodiments, the memory 20 can also be omitted, and the number of operating commands corresponding to the number of types of movements of the stylus 11 can be preset in the processor 30.

In the present embodiment, the electronic device can sense the movement of the stylus 11 by electromagnetic induction, therefore, the stylus 11 does not need to contact the inducting layer 122 when operating the electronic device 100.

While certain embodiments have been described and exemplified above, various other embodiments will be apparent to those skilled in the art from the foregoing disclosure. The invention is not limited to the particular embodiments described and exemplified, and the embodiments are capable of considerable variation and modification without departure from the scope and spirit of the appended claims.

What is claimed is:

1. An electronic device comprising:
an electromagnetic input device comprising:
a movable magnetized stylus; and
an inducting module comprising
a plurality of inducting cells, each inducting cell comprising a coil for generating an inducting voltage according to the change of magnetic flux through the coil;
a controller configured for determining the type of movement of the stylus according to the inducting voltages generated by the plurality of coils of the plurality of inducting cells;
a memory storing a plurality of operating commands corresponding to a plurality of types of movements of the stylus; and
a processor generating an operating command for operating the electronic device corresponding to the type of movement of the stylus determined by the controller.

2. The electronic device of claim 1, wherein the stylus is a magnetized pen.

3. The electronic device of claim 1, wherein the inducting module comprises a transparent substrate and a transparent inducting layer, and the plurality of inducting cells are formed on the transparent inducting layer.

4. The electronic device of claim 3, wherein the inducting module further comprises a transparent cover, and the inducting layer is sandwiched between the substrate and the cover.

5. The electronic device of claim 4, wherein the substrate and the cover are made of glass or transparent resin.

6. The electronic device of claim 5, wherein each inducting cell further comprises a differential unit for generate a differential voltage by amplifying the induced voltage generated by the coil.

7. The electronic device of claim 6, wherein the inducting module further comprises:
a plurality of gate lines each connected to the plurality of inducting cells; and
a plurality of output lines each connected to the plurality of inducting cells,
and the controller comprises:
a scanning unit connected to the gate lines and is operable to output gate signals to the gate lines, line by line, to enable the differential units to output the differential signals;
a comparing unit connected to the output lines and configured for comparing the largest differential voltage of the differential units to a predetermined positive threshold voltage; and
a determining unit determining the position of the stylus relative to the inducting layer according to the comparing result of the comparing unit, and determine the type of movement of the stylus according to the position change of the stylus.

8. The electronic device of claim 7, wherein the predetermined positive threshold voltage is preset in the comparing unit.

9. The electronic device of claim 7, wherein if the largest differential voltage of the differential units of the inducting layer is larger than the predetermined positive threshold voltage, the determining unit will determine that the stylus is substantially close to the coil of the inducting layer corresponding to the largest differential voltage.

10. The electronic device of claim 1, wherein the types of movements of the stylus is distinguished according to characteristics of the movement of the stylus, the characteristics of the movement of the stylus is selected from the group consisting of acceleration, speed, and direction of the movement.

11. An electronic device comprising:
an electromagnetic input device comprising:
a movable magnetized stylus; and
an inducting module comprising
a plurality of inducting cells, each inducting cell comprising a coil for generating an inducting voltage according to the change of magnetic flux through the coil;
a controller configured for determining the type of movement of the stylus according to the inducting voltages generated by the plurality of coils of the plurality of inducting cells; and
a processor preset a plurality of operating commands corresponding to a plurality of types of movements of the stylus, and configured for generating an operating command for operating the electronic device corresponding to the type of movement of the stylus determined by the controller.

12. The electronic device of claim 11, wherein the stylus is a magnetized pen.

13. The electronic device of claim 11, wherein the inducting module comprises a transparent substrate and a transparent inducting layer, and the plurality of inducting cells are formed on the transparent inducting layer.

14. The electronic device of claim 13, wherein the inducting module further comprises a transparent cover, and the inducting layer is sandwiched between the substrate and the cover.

15. The electronic device of claim 14, wherein the substrate and the cover are made of glass or transparent resin.

16. The electronic device of claim 15, wherein each inducting cell further comprises a differential unit for generate a differential voltage by amplifying the induced voltage generated by the coil.

17. The electronic device of claim 16, wherein the inducting module further comprises:
a plurality of gate lines each connected to the plurality of inducting cells; and
a plurality of output lines each connected to the plurality of inducting cells,
and the controller comprises:
a scanning unit connected to the gate lines and is operable to output gate signals to the gate lines, line by line, to enable the differential units to output the differential signals;
a comparing unit connected to the output lines and configured for comparing the largest differential voltage of the differential units to a predetermined positive threshold voltage; and
a determining unit determining the position of the stylus relative to the inducting layer according to the comparing result of the comparing unit, and determine the type of movement of the stylus according to the position change of the stylus.

18. The electronic device of claim 17, wherein the predetermined positive threshold voltage is preset in the comparing unit.

19. The electronic device of claim 17, wherein if the largest differential voltage of the differential units of the inducting layer is larger than the predetermined positive threshold voltage, the determining unit will determine that the stylus is substantially close to the coil of the inducting layer corresponding to the largest differential voltage.

20. The electronic device of claim 11, wherein the types of movements of the stylus is distinguished according to characteristics of the movement of the stylus, the characteristics of the movement of the stylus is selected from the group consisting of acceleration, speed, and direction of the movement.
